(19) United States
(12) Patent Application Publication
(10) Pub. No.: US 2011/0081799 A1
(43) Pub. Date: Apr. 7, 2011

(54) Adjusting Module And Method

(75) Inventor: Ming-Hsien Tang, Hsinchu (TW)

(73) Assignee: Arcadyan Technology Corp., Hsinchu (TW)

(21) Appl. No.: 12/894,077

(22) Filed: Sep. 29, 2010

(30) Foreign Application Priority Data
Oct. 1, 2009 (TW) 098133458

(51) Int. Cl. H01R 13/64

(52) U.S. Cl. 439/374

(57) ABSTRACT

An adjusting module is provided. The adjusting module includes a fixed object and a movable object. The fixed object includes a first fixing base and a sliding rail. The first fixing base includes a socket; and at least two guiding pins configured around the socket. The movable object includes a holder sliding on the sliding rail; and a second fixing base configured on the holder and a plug having at least two guiding holes configured around the plug and positioned corresponding to the guiding pins.

### FIELD OF THE INVENTION

The present invention relates to an adjusting module and method, and more particular to an adjusting module and method for precisely connecting a socket and a plug.

### BACKGROUND OF THE INVENTION

The currently available plug-in electronic products are connected by using the exclusive connector module, i.e. one product can just be connected by using the specific plug and socket. Because those specific connector modules are not popularly used, they are expensive. Besides, the apparatuses that use those specific connector modules will be limited by the supporters.

The currently available plug-in electronic products are produced with the foolproof function to prevent the incorrect assembly. However, it should be careful when the pins of the plug are plugged into the holes of the socket. Once the connecting method or angle is incorrect, the pins will be damaged. Then, the connector with the sliding rail is developed to facilitate the connection of the plug with the socket correctly and conveniently. Nevertheless, when any component is manufactured, it always has the tolerance, which will cause an orientation issue during the connecting process.

In order to overcome the drawbacks in the prior art, an adjusting module and method are provided. The particular design in the present invention not only solves the problems described above, but also is easy to be implemented. Thus, the present invention has the utility for the industry.

### SUMMARY OF THE INVENTION

In accordance with an aspect of the present invention, an adjusting module is provided. The adjusting module includes a fixed object and a movable object. The fixed object includes a first fixing base and a sliding rail. The first fixing base includes a socket; and at least two guiding pins configured around the socket. The movable object includes a holder sliding on the sliding rail; and a second fixing base configured on the holder and a plug having at least two guiding holes configured around the plug and positioned corresponding to the guiding pins.

According to the adjusting module described above, the socket and the plug are a set of changeable electronic connecting devices.

According to the adjusting module described above, the set of changeable electronic connecting devices is one selected from a group consisting of a D-sub, a DVI, a dual-DVI, an AV, a USB and an IEEE connecting device set.

According to the adjusting module described above, the holder carries an electronic device.

In accordance with another aspect of the present invention, an adjusting method is provided. The method includes steps of providing at least a first guiding element around the socket; providing at least a second guiding element around the plug; sliding the plug toward the socket; urging the second guiding element to engage with the first guiding element to precisely orientate a relative location between the socket and the plug; and connecting the socket and the plug.

According to the method described above, the socket and the plug are a set of changeable electronic connecting devices.

According to the method described above, the set of changeable electronic connecting devices is one selected from a group consisting of a D-sub, a DVI, a dual-DVI, an AV, a USB and an IEEE connecting device set.

In accordance with a further aspect of the present invention, an adjusting module is provided. The adjusting module includes a fixed object and a movable object. The fixed object includes a socket; and a first guiding element configured around the socket. The movable object includes a plug; and a second guiding element configured around the plug and engageable with the first guiding element.

According to the adjusting module described above, the first guiding element is at least two guiding pins, and the second guiding element is at least two guiding holes.

According to the adjusting module described above, the socket and the plug are a set of changeable electronic connecting devices.

According to the adjusting module described above, the set of changeable electronic connecting devices is one selected from a group consisting of a D-sub, a DVI, a dual-DVI, an AV, a USB and an IEEE connecting device set.

According to the adjusting module described above, the first and the second guiding elements are a pair of a guiding pin and a guiding hole for adjusting a relative location between the socket and the plug when the socket and the plug are connected.

According to the adjusting module described above, the fixed object further comprises a sliding rail, and the movable object further comprises a holder, wherein the holder slides on the sliding rail.

According to the adjusting module described above, the holder carries an electronic device.

The above aspects and advantages of the present invention will become more readily apparent to those ordinarily skilled in the art after reviewing the following detailed descriptions and accompanying drawings, in which:

### BRIEF DESCRIPTION OF THE DRAWINGS

FIG. 1 shows the adjusting module according to a preferred embodiment of the present invention; and

FIG. 2 shows the adjusting method according to a preferred embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purposes of illustration and description only; it is not intended to be exhaustive or to be limited to the precise form disclosed.

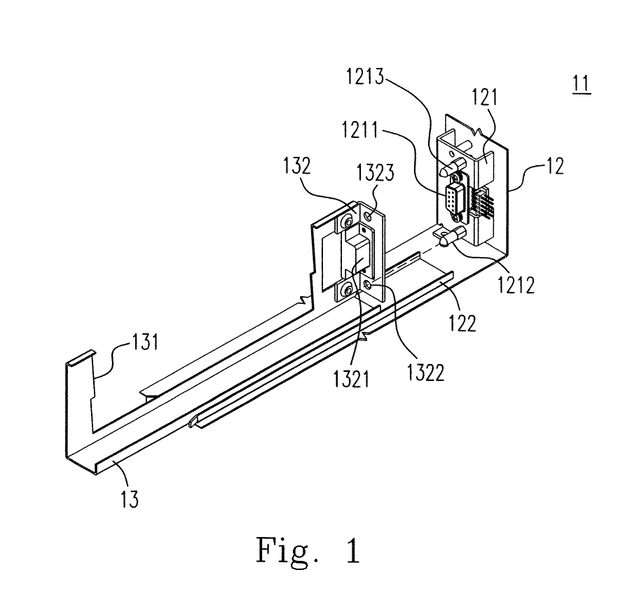

Please refer to FIG. 1, which shows the adjusting module according to a preferred embodiment of the present invention. The adjusting module 11 includes a fixed object 12 and a movable object 13. A fixed base 121 and a sliding rail 122 are disposed on the fixed object 12, and a connecting socket 1211 and two guiding pins 1212, 1213 are disposed on the fixed base 1211, wherein the guiding pins 1212, 1213 are configured around the connecting socket 1211. The sliding rail 122 is configured to provide a track for the movable object 13 to slide thereon. A holder 131 and a fixed base 132 are disposed on the movable object 13, wherein a plug 1321 and two guiding holes 1322, 1323 are configured on the fixed base 132. The guiding holes 1322, 1323 are configured around the plug 1321 and positioned corresponding to the guiding pins 1212, 1213.

In the adjusting module 11, the holder 131 on the movable object 13 is configured to provide a space for containing the electronic device. The fixed bases 121, 132 are configured to provide space for containing the socket 1211 and the plug 1321, wherein the socket 1211 and the plug 1321 are a pair of plug/socket modules and can be replaced according to different electronic devices and different demands. The conventional plug/socket modules can be used in the adjusting module 11 of the present invention, e.g. the D-sub, the DVI, the dual-DVI, the AVI, etc., and even the USB or IEEE connecting devices can also be used therein. In the present invention, the sliding rail 122 is configured on the fixed object 12 to provide a fixed track for the movable object 13 to slide thereon, thereby enabling the assembling to be fast and precise. Besides, the configurations of the guiding pins 1212, 1213 and the guiding holes 1322, 1323 are the key of the present invention. During the manufacture process of any element, the tolerance is impossible to be avoided. Although the tolerance is tiny, the connection of the plug 1321 having plural pins with the socket 1211 having plural holes might fail if the orientation therebetween is not precise. Therefore, even if the sliding rail is applied to the connecting module, it is still necessary to assemble the connectors by the operator or the user with his eye sight to overcome the error caused by the tolerance. In the present invention, the two guiding pins 1212, 1213 are configured on the fixed base 121 on the fixed object 12, and the two guiding holes 1322, 1323 whose positions are corresponding to the two guiding pins 1212, 1213 are configured on the fixed base 132 on the movable object 13. This enables the assembling to be simpler and faster without the need of the operator or user with his eye sight.

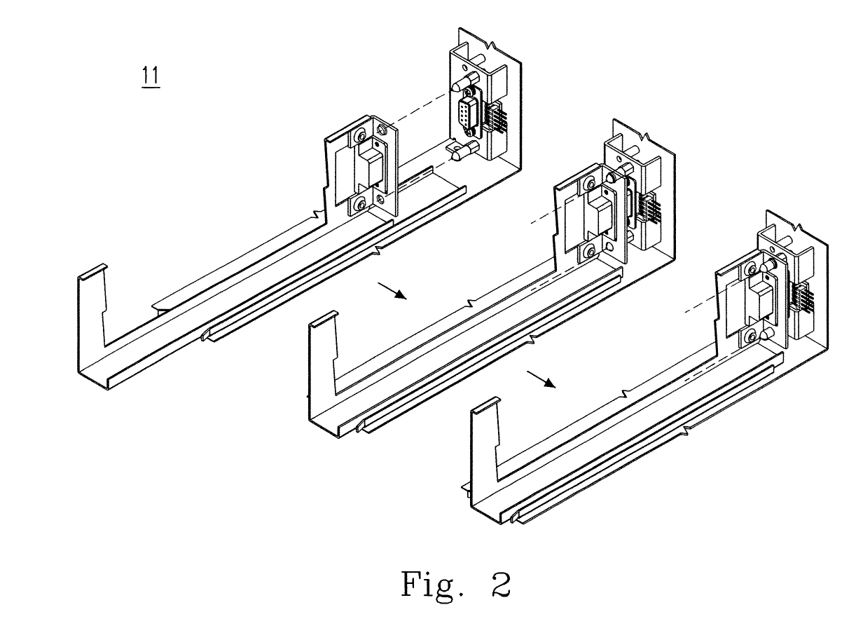

Please refer to FIG. 2, which shows the adjusting method according to a preferred embodiment of the present invention. The movable object 13 slides in the sliding rail 122 to drive the plug 1321 to approach the connecting socket 1211. Before the plug 1321 contacts the connecting socket 1211, the guiding pins 1212, 1213 will pass through the guiding holes 1322, 1323 first. Because the front ends of the guiding pins 1212, 1213 are sharper, it is easy for the guiding pins 1212, 1213 to pass through the guiding holes 1322, 1323 with larger areas, thereby leading the plug 1321 to be connected with the connecting socket 1211 precisely. In this way, the pins of the plug 1321 and the holes of the connecting socket 1211 can be well oriented without the need of the operator or the user with his eye sight and without spending extra time.

Besides, in the adjusting module of the present invention, at least two guiding pins and at least two guiding holes have to be used to achieve the orientation effect. Although more guiding pins and guiding holes will bring a better effect, however they occupy more space and the manufacturing cost thereof are higher. Therefore, the use of two guiding pins and two guiding holes as described in the above-mentioned embodiments is the optimal way.

While the invention has been described in terms of what is presently considered to be the most practical and preferred embodiment, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An adjusting module, comprising:
a fixed object comprising:
a first fixing base comprising:
a socket; and
at least two guiding pins configured around the socket; and
a sliding rail; and
a movable object comprising:
a holder sliding on the sliding rail; and
a second fixing base configured on the holder and a plug having at least two guiding holes configured around the plug and positioned corresponding to the guiding pins.

2. An adjusting module as claimed in claim 1, wherein the socket and the plug are a set of changeable electronic connecting devices.

3. An adjusting module as claimed in claim 2, wherein the set of changeable electronic connecting devices is one selected from a group consisting of a D-sub, a DVI, a dual-DVI, an AV, a USB and an IEEE connecting device set.

4. An adjusting module as claimed in claim 1, wherein the holder carries an electronic device.

5. An adjusting method of connecting a socket and a plug, comprising steps of:
a. providing at least a first guiding element around the socket;
b. providing at least a second guiding element around the plug;
c. sliding the plug toward the socket;
d. urging the second guiding element to engage with the first guiding element to precisely orientate a relative location between the socket and the plug; and
e. connecting the socket and the plug.

6. A method as claimed in claim 5, wherein the socket and the plug are a set of changeable electronic connecting devices.

7. A method as claimed in claim 6, wherein the set of changeable electronic connecting devices is one selected from a group consisting of a D-sub, a DVI, a dual-DVI, an AV, a USB and an IEEE connecting device set.

8. An adjusting module, comprising:
a fixed object comprising:
a socket; and
a first guiding element configured around the socket; and
a movable object comprising:
a plug; and
a second guiding element configured around the plug and engageable with the first guiding element.

9. An adjusting module as claimed in claim 8, wherein the first guiding element is at least two guiding pins, and the second guiding element is at least two guiding holes.

10. An adjusting module as claimed in claim 8, wherein the socket and the plug are a set of changeable electronic connecting devices.

11. An adjusting module as claimed in claim 10, wherein the set of changeable electronic connecting devices is one selected from a group consisting of a D-sub, a DVI, a dual-DVI, an AV, a USB and an IEEE connecting device set.

12. An adjusting module as claimed in claim 8, wherein the first and the second guiding elements are a pair of a guiding pin and a guiding hole for adjusting a relative location between the socket and the plug when the socket and the plug are connected.

13. An adjusting module as claimed in claim 8, wherein the fixed object further comprises a sliding rail, and the movable object further comprises a holder, wherein the holder slides on the sliding rail.

14. An adjusting module as claimed in claim 13, wherein the holder carries an electronic device.
